(19) United States
(12) Patent Application Publication
(10) Pub. No.: US 2020/0354155 A1
(43) Pub. Date: Nov. 12, 2020

(54) APPARATUS FOR TRANSPORTING BARS WITH CYLINDRICAL SHAPE

(71) Applicant: National Applied Research Laboratories, Taipei City (TW)

(72) Inventors: Han-Chao Chang, Taipei City (TW); Wen-Tse Hsiao, Taipei City (TW); Yu-Chen Hsieh, Taipei City (TW)

(21) Appl. No.: 16/532,745

(22) Filed: Aug. 6, 2019

(30) Foreign Application Priority Data
May 7, 2019 (TW) 108115780

(51) Int. Cl. B65G 35/00; B65G 47/88; B65G 43/08; G06M 7/04

(52) U.S. Cl. CPC B65G 35/00; B65G 47/883; B65G 2203/0241; G06M 7/04; B65G 2201/0217; B65G 43/08

(57) ABSTRACT

An apparatus for transporting a plurality of bars having an axial direction is disclosed. The apparatus includes a storage device and a conveying device. The storage device includes an accommodating area configured to accommodate the plurality of bars side by side along a first direction substantially perpendicular to the axial direction; a first ramp having a front end and a rear end, wherein the front end is adjacent to the accommodating area and receives the plurality of bars sequentially, and the received plurality of bars roll from the front end to the rear end on the first ramp in a second direction; and a counting device adjacent to the rear end and operable to allow a predetermined quantity of the plurality of bars to exit the storage device in the second direction. The conveying device includes a receiving end, an output end and a second ramp.

### CROSS-REFERENCE TO RELATED APPLICATION AND CLAIM OF PRIORITY

The application claims the benefit of Taiwan Patent Application No. 108115780, filed on May 7, 2019, at the Taiwan Intellectual Property Office, the disclosures of which are incorporated herein in their entirety by reference.

### FIELD OF THE INVENTION

The present invention is related to a transportation apparatus, and more particularly to an apparatus for transporting metal bars with cylindrical shape.

### BACKGROUND OF THE INVENTION

The manufacturing industry of metal products is composed of industrial chains formed by upstream, middle stream and downstream manufacturers. The metal plants will buy carbon steel, stainless steel or brass bars from upstream suppliers and store them on the iron frames. Downstream manufacturers will go to metal plants to buy metal bars of different lengths (ranging from 1 cm to 1 m) and bring them back to their own factories for machining. Traditionally, metal plant workers must carry the bars from the iron frames to the cutting machine by manpower or using a crane, and then clean the finished items before shipping them to downstream manufacturers. This transporting and processing method is time-consuming and low-capacity.

Handling of metal bars in storage environments is usually a no-easy task. Due to the high density of metals, heavy duty handling devices are often required. The quantity control during the transportation process requires timely and reliable on-site data to accurately meet the shipping requirements. These are all requirements that are currently not easily achievable in a manual operation process. In order to overcome the drawbacks set forth above in the prior art, a new design for the transporting apparatus is required.

### SUMMARY OF THE INVENTION

Thus, there is a need to develop a novel apparatus for transporting cylindrical bars with high efficiency and good quantity control.

In accordance with one aspect of the present invention, an apparatus for transporting a plurality of bars having an axial direction is disclosed. The apparatus includes a storage device and a conveying device. The storage device includes an accommodating area configured to accommodate the plurality of bars side by side along a first direction substantially perpendicular to the axial direction; a first ramp having a front end and a rear end, wherein the front end is adjacent to the accommodating area and receives the plurality of bars sequentially, and the received plurality of bars roll from the front end to the rear end on the first ramp in a second direction; and a counting device adjacent to the rear end and operable to allow a predetermined quantity of the plurality of bars to exit the storage device in the second direction from the rear end of the first ramp. The conveying device includes a receiving end adjacent to the rear end, and configured to sequentially receive the predetermined quantity of the plurality of bars; an output end receiving the predetermined quantity of the plurality of bars from the receiving end, and transporting the received predetermined quantity of the plurality of bars in a third direction; and a second ramp connecting the receiving end and the output end, and allowing the plurality of bars to move from the receiving end to the output end due to a gravity.

In accordance with another aspect of the present invention, a transporting apparatus for transporting cylinders having an axial direction is disclosed. The transporting apparatus comprises a storage and a conveying device. The transporting apparatus includes an accommodating area configured to accommodate the cylinders side by side along a first direction substantially perpendicular to the axial direction; a first ramp having a front end and a rear end, wherein the front end is adjacent to the accommodating area and receives the cylinders sequentially, and the received cylinders roll from the front end to the rear end on the first ramp in a second direction; and a counting device adjacent to the rear end and operable to allow a predetermined quantity of the cylinders to exit the storage in the second direction from the rear end of the first ramp.

The apparatus for transporting cylindrical bars according to the present invention can avoid manual operation while providing reliable on-site data, which can be used in automated storage systems and production lines. Thus, the present invention has utility for industry.

The objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic diagram showing an apparatus for transporting bars having a cylindrical shape according to one embodiment of the present invention;

FIG. 2 is a schematic diagram showing an apparatus for transporting bars having a cylindrical shape according to another embodiment of the present invention;

FIG. 3 is a schematic diagram showing an apparatus for transporting bars having a cylindrical shape according to the other embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

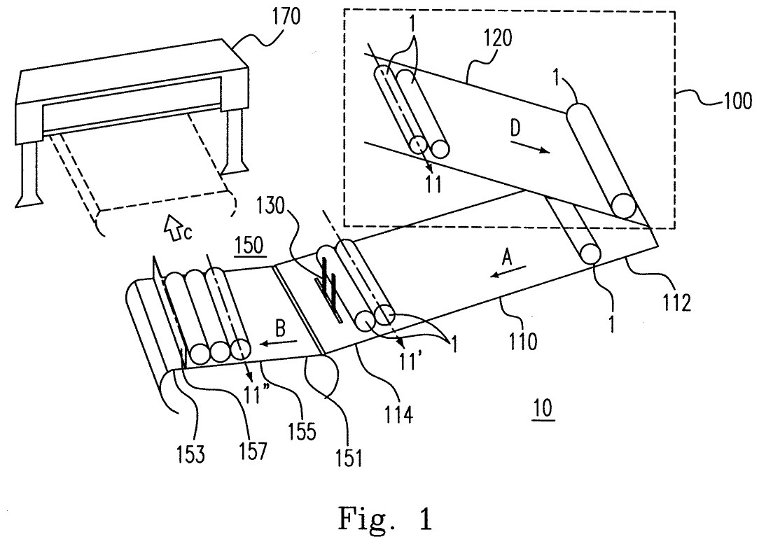

Please refer to FIG. 1, which shows an apparatus for transporting bars having a cylindrical shape according to one embodiment of the present invention. The apparatus includes a storage device 10 and a conveying device 150. The storage device 10 includes an accommodating area 100 configured to accommodate the plurality of bars 1, each of which has a cylindrical shape and an axial direction 11. A first storage ramp 110 and a second storage ramp 120 are disposed in the accommodating area 100 for accommodating the plurality of bars 1, which are placed side by side respectively along the directions A and D substantially perpendicular to the axial direction 11 of the bars 1. The first storage ramp 110 and the second storage ramp 120 is arranged to constitute a zigzag configuration, so the directions A and D are different. According to the zigzag configuration formed by the first and the second storage ramps 110, 120, it is appreciated that such a configuration may allow the storage area 10 to be expanded higher along the upper direction so as to save the required floor area and make use of the gravity to place the bars 1 side by side on the ramps. When necessary, the concept of zigzagging ramps can be continued upwards, i.e., at least one of the first and the second storage ramps 110, 120 can be composed of a plurality of sub ramps (not shown) which constitute a further zigzag configuration.

Due to the fact that the density of metals is much higher than that of non-metal materials, the bars 1 is preferably made of metallic material such as iron or copper, and thus the bars 1 can easily roll and stay side by side to each other along the directions A or D perpendicular to the axial direction 11 with the aid of gravity. However, in some embodiments, non-metallic bars 1 with cylindrical shape can also roll and stay side by side on the first and the second storage ramps 110, 120 due to gravity. In this respect, the present invention is also applicable for metal bars having a shape which is easy to roll such as hexagonal or octagonal columns. For the sake of convenient explanation, metal bars 1 having a cylindrical outer shape is used as examples hereinafter, and those skilled in the art can understand that the present invention can be applied to the storage and transportation methods for solid or hollow column materials with similar shape of cylinders.

Refer again to FIG. 1, the first storage ramp 110 has a front end 112 and a rear end 114. The front end 110 is located on a higher horizontal position and adjacent to the accommodating area 110 for receiving the plurality of bars 1 sequentially. The plurality of bars 1 can roll from the front end 112 to the rear end 114 on the first storage ramp 110 in the direction A because the front end 110 is located on relatively higher horizontal position. A counting device 130, such as a baffle or a barrier controllable by a program, is disposed near the rear end 114 and operable to allow a predetermined quantity (such as 3 for instance) of the plurality of bars 1 to exit the storage device 10 in the direction A from the rear end 114 of the first storage ramp 110.

The conveying device 150 includes a receiving end 151, an output end 153 and a transporting ramp 155. The receiving end 151 is adjacent to the rear end 114 of the first storage ramp 110 and configured to sequentially receive the predetermined quantity (such as 3 as illustrated in FIG. 1) of the plurality of bars 1. The horizontal position of the output end 153 is lower than that of the receiving end 151, and the transporting ramp 155 connects the receiving end 151 and the output end 153 thereinbetween. The bars 1 on the transporting ramp 155 is allowed to roll along the direction B from the receiving end 151 to the output end 153 due to the effect of gravity. Therefore, the output end 153 is configured to receive the predetermined quantity of the plurality of bars 1 from the receiving end 151. In one embodiment of the present invention, the output end 153 transports the received predetermined quantity of the plurality of bars 1 in the direction C.

It is appreciated from FIG. 1 that, all the axial directions 11′ of the cylindrical bars 1 are the same at an initial moment upon being received at the receiving end 151, and each of the cylindrical bars 1 rolls at every moment along the direction B substantially perpendicular to the axial direction 11′. In addition, the direction C is substantially perpendicular to the direction B, i.e., the direction C is substantially parallel to the axial directions 11′ of the cylindrical bars 1 at the output end 153. The bars 1 are eventually placed side by side after passing through the transporting ramp 155 due to the effect of gravity.

According to one embodiment of the present invention, a control device 157 is further disposed on the output end 153 of the conveying device 150. In an embodiment, the control device 157 is equipped with appropriate sensing element (not shown) for identifying the quantity of the bars 1 arrived at the output end 153, and the conveying device 150 moves along the direction C to a position near the tooling machine 170 so as to allow the bars 1 be processed for shipping when the number of the bars 1 at the output end 153 achieves a predetermined quantity. In one another embodiment, the number of the bars 1 on the conveying device can be controlled by the counting device 130 alone. When the number of the bars 1 having left the rear end 114 of the first storage ramp 110 has achieved the predetermined number, the counting device 130 no longer release the bars 1, and the conveying device 150 moves along the direction C afterwards.

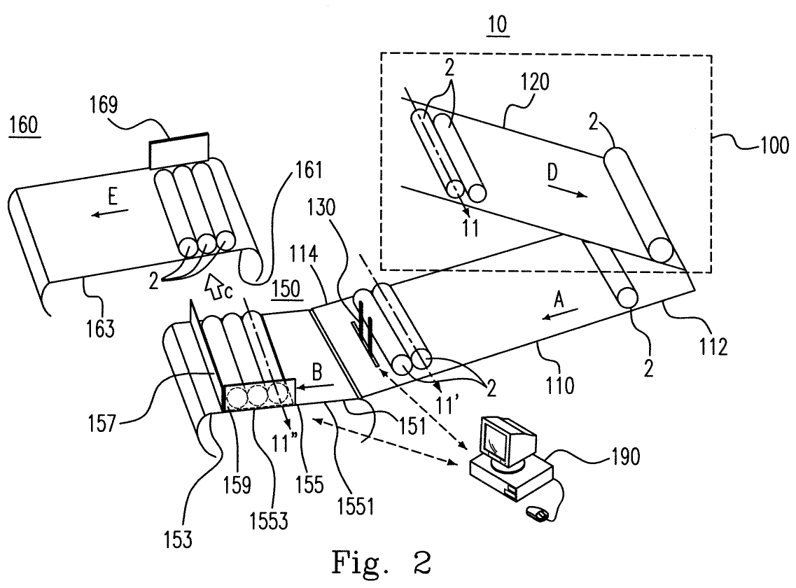

Please refer to FIG. 2, which shows an apparatus for transporting bars having a cylindrical shape according to another embodiment of the present invention. The apparatus comprises a storage device 10 and a conveying device 150. Notably, the storage device 10 is similar to that in the embodiments as illustrated in FIG. 1 and set forth above, and thus there is no need to repeat.

According to FIG. 2, the conveying device 150 is used for transporting cylinders 2 relatively easy to roll. Being different from that in FIG. 1, the conveying device 150 further includes a controller 190 and an output device 159 disposed at the output end 153. The receiving end 151 is configured to receive the cylinders 2 having an axial direction 11′ at an initial moment upon being received at the receiving end 151. The transporting ramp 155 has a first end 1551 connected to the receiving end 151 and a second end 1553 connected to the output end 153, wherein the horizontal position of the first end 1551 is higher than that of the second end 1553, and therefore the cylinders 2 can roll on the transporting ramp 155 from the first end 1551 to the second end 1553 along the direction B substantially perpendicular to the axial direction 11″ of the cylinders 2 at every moment during the rolling.

The controller 190 can be disposed on a remote end and communicate with the counting device 130 via either wired or wireless means to control a parameter (the quantity or total weight for examples) of the cylinders 2. The output device 159 ships out the cylinders 2 along the direction C when the parameter complies with a predeteimined value (for example, the quantity of cylinders 2 is 3 or the total weight achieves 200 kilograms). The direction C is substantially parallel to the axis direction 11″. The controller 190 in FIG. 2 is illustrated as a desktop computer. A user may instruct the operations of the devices by operating the desktop computer at the remote site. On the other hand, the controller 190 can also be realized by a micro processor bearing an application program disposed on a circuit board to carry out the same functions.

Based on the device configuration as shown in FIG. 2, the skilled person in the art can understand that, the embodiments shown in FIG. 1 may also add a controller 190 at a remote site communicating with the counting device 130 via either wired or wireless methods to actually as well as timely control the counting device 130.

According to FIG. 2, the conveying device 150 can transport the cylinders 2 to a machine shop (not shown) via an additional conveying device 160 which may be the same as the conveying device 150 or other types of conveyers. In one embodiment of the present invention, the additional conveying device 160 has a receiving end 161 and an output end 163, and an output device 169 is disposed at the receiving end 161. The cylinders 2 can be allowed to move or roll along the direction E when arrived at the receiving end 161 of the additional conveying device 160.

The difference between the embodiments in FIGS. 1 and 2 is that the conveying device 150 in FIG. 1 directly moves the bars 1 to the location of the tooling machine 170 while the conveying device 150 in FIG. 2 transports the cylinders 2 to the additional conveying device 160. The transporting ramp 155 in the conveying device 150 is straight, and it can be designed to a curved ramp to change the axial direction 11′ of the bars 1 or the cylinders 2 when necessary.

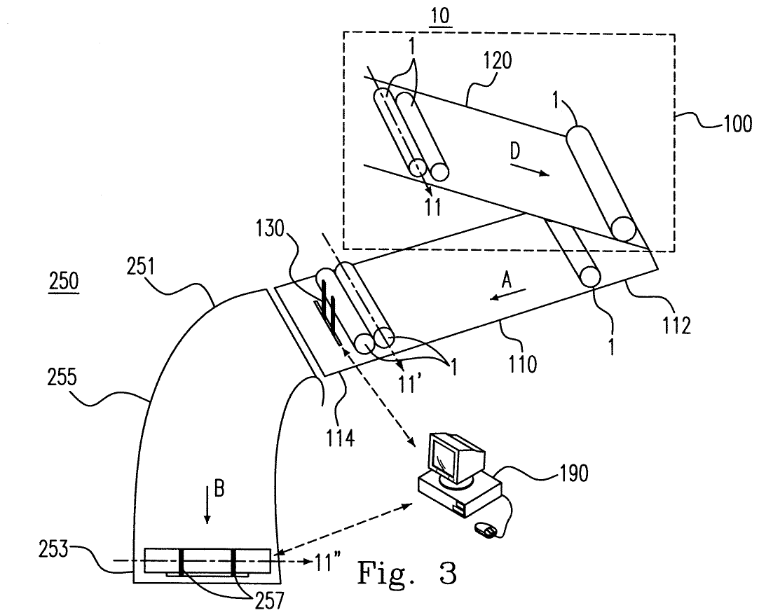

Please refer to FIG. 3, which shows an apparatus for transporting bars having a cylindrical shape according to the other embodiment of the present invention. The apparatus comprises a storage device 10 and a conveying device 250, wherein the storage device 10 is similar to that in the embodiments as illustrated in FIGS. 1 and 2, and thus there is no need to repeat.

According to FIG. 3, the conveying device 250 includes a receiving end 251, an output end 253 and a transporting ramp 255. The receiving end 251 is adjacent to the rear end 114 of the first storage ramp 110 and configured to sequentially receive the predetermined quantity (such as 3 as illustrated in FIG. 3) of the plurality of bars 1. The horizontal position of the output end 253 is lower than that of the receiving end 251, and the transporting ramp 255 connects the receiving end 251 and the output end 253 thereinbetween. The bars 1 on the transporting ramp 255 is allowed to roll along the direction B from the receiving end 251 to the output end 253 due to the effect of gravity. Therefore, the output end 253 is configured to receive the predetermined quantity of the plurality of bars 1 from the receiving end 151. In one embodiment of the present invention, the output end 153 transports the received predetermined quantity of the plurality of bars 1 in the direction C. A controller 190 can be disposed on a remote end and communicate with the counting device 130 via either wired or wireless means to control a parameter (the quantity or total weight for examples) of the cylinders 2. The transporting ramp 255 is curved, and the other features thereof are the same as those of the transporting ramp 155 in FIG. 2 so there is no need to repeat. The curved shape of the transporting ramp 255 can change the axial direction 11″ of the bars 1 for the need of subsequent processing. According to one embodiment, a control device 257 is disposed at the output end 253. The control device 257 may be equipped with sensing elements (not shown) to identify the number of the bars 1 arrived at the output end 253. The control device 257 can be a baffle or a barrier for use to stop the bars 1 from dropping out.

The accommodating area 100 of the storage device 10 includes the first and the second storage ramps 110, 120 for accommodating the plurality of bars 1 which are placed side by side respectively along the directions A and D. The first storage ramp 110 and the second storage ramp 120 is arranged to constitute a zigzag configuration, so the directions A and D are different. When necessary, the concept of zigzagging ramps can be continued upwards, i.e., at least one of the first and the second storage ramps 110, 120 can be composed of a plurality of sub ramps (not shown) which constitute a further zigzag configuration.

The present invention can fully satisfy the need of high-speed automation, and reduce the burden of manual operation, which is a technology breakthrough.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An apparatus for transporting a plurality of bars having an axial direction, comprising:
a storage device including:
an accommodating area configured to accommodate the plurality of bars side by side along a first direction substantially perpendicular to the axial direction;
a first ramp having a front end and a rear end, wherein the front end is adjacent to the accommodating area and receives the plurality of bars sequentially, and the received plurality of bars roll from the front end to the rear end on the first ramp in a second direction; and
a counting device adjacent to the rear end and operable to allow a predetermined quantity of the plurality of bars to exit the storage device in the second direction from the rear end of the first ramp; and
a conveying device including:
a receiving end adjacent to the rear end, and configured to sequentially receive the predetermined quantity of the plurality of bars;
an output end receiving the predetermined quantity of the plurality of bars from the receiving end, and transporting the received predetermined quantity of the plurality of bars in a third direction; and
a second ramp connecting the receiving end and the output end, and allowing the plurality of bars to move from the receiving end to the output end due to a gravity.

2. The apparatus according to claim 1, wherein the storage device further includes a third ramp configured to accommodate the plurality of bars side by side along a fourth direction.

3. The apparatus according to claim 2, wherein the third ramp and the first ramp constitute a zigzag configuration, and the first direction and the fourth direction are different.

4. The apparatus according to claim 1, wherein the third direction is substantially parallel to the axial direction.

5. The apparatus according to claim 1, wherein the output end includes an output device being controlled to assure that the plurality of bars from the receiving end are forwarded to a tooling machine in the third direction when a number of the bars achieves the predetermined quantity.

6. The apparatus according to claim 1, wherein the output end includes an output device being controlled to assure that the plurality of bars from the receiving end are forwarded to another conveying device in the third direction when a number of the bars achieves the predetermined quantity.

7. A transporting apparatus for transporting cylinders having an axial direction, comprising:
a storage including:
an accommodating area configured to accommodate the cylinders side by side along a first direction substantially perpendicular to the axial direction;
a first ramp having a front end and a rear end, wherein the front end is adjacent to the accommodating area and receives the cylinders sequentially, and the received cylinders roll from the front end to the rear end on the first ramp in a second direction; and
a counting device adjacent to the rear end and operable to allow a predetermined quantity of the cylinders to exit the storage in the second direction from the rear end of the first ramp; and
a conveying device including:
a receiving end configured to receive the cylinders, wherein each of the cylinders has an axial direction, all the axial directions of the cylinders are the same at an initial moment upon being received at the receiving end, and each the cylinder rolls at every moment along a direction substantially perpendicular to the axial direction;
a second ramp having a first end connected to the receiving end and a second end, and allowing the cylinders to move from the first end to the second end due to a gravity;
an output end connected to the second end and receiving the cylinders.

8. The apparatus according to claim 7, further comprising a controller configured to control a parameter associated to the cylinders.

9. The apparatus according to claim 8, further comprising an output device configured to output the cylinders along a third direction when the parameter meets a predetermined value.

10. The apparatus according to claim 9, wherein the predetermined value is one of a weight and a quantity.

11. The apparatus according to claim 9, wherein the second ramp has a curved shape.

12. The apparatus according to claim 9, wherein the third direction is the same as the axial direction at the initial moment.

13. The apparatus according to claim 7, wherein the cylinders are outputted along a direction substantially parallel to the axial direction.

14. The apparatus according to claim 7, wherein the conveying device is connected to another conveying device.

15. The apparatus according to claim 14, wherein the another conveying device is configured to forward the cylinders to a processing station.

16. The apparatus according to claim 7, further comprising a third ramp disposed in the accommodating area, configured to accommodate the cylinders, and connected to the front end of the first ramp.
